(19) United States
(12) Patent Application Publication
(10) Pub. No.: US 2012/0249794 A1
(43) Pub. Date: Oct. 4, 2012

(54) IMAGE DISPLAY SYSTEM

(75) Inventors: Kouei KIYO, Kobe-shi (JP); Yasuyoshi SAWADA, Kobe-shi (JP); Satoshi HARUMOTO, Kobe-shi (JP); Takeshi TANAKA, Kobe-shi (JP); Goro ASAI, Toyota-shi (JP); Yujiro OBATA, Inuyama-shi (JP); Toshinori ESAKA, Miyoshi-shi (JP); Yohei SATOMI, Nisshin-shi (JP)

(73) Assignee: FUJITSU TEN LIMITED, Kobe-shi (JP)

(21) Appl. No.: 13/414,291

(22) Filed: Mar. 7, 2012

(30) Foreign Application Priority Data
Mar. 31, 2011 (JP) 2011-080742

(51) Int. Cl. H04N 7/18

(52) U.S. Cl. 348/148; 348/E07.085

(57) ABSTRACT

An image display system including a synthesized image generation section that generates a synthesized image representing a vehicle and circumstances around the vehicle viewed from a virtual viewpoint based on captured images obtained by cameras disposed on the vehicle, a navigation device that displays the synthesized image and the captured images on a display screen, an obstacle detection section that detects an obstacle, and an indication addition section that, when the obstacle is detected, adds an alarm indication to call attention to at least one of an area of the display screen except the synthesized image, and a surrounding area of the synthesized image is provided.

This application is a new U.S. patent application that claims priorities to Japanese Application No. 2011-080742, filed on Mar. 31, 2011, the content of which is incorporated herein by reference.

### FIELD OF THE INVENTION

The present invention relates to a technique for displaying an image in a vehicle.

### BACKGROUND OF THE INVENTION

Conventionally, an image display system that is mounted in a vehicle such as an automobile and that displays a surrounding image around the vehicle based on captured images obtained by onboard cameras on a display in a compartment is known. A user (typically, driver) can use this image display system to see the area around the vehicle in real time.

For example, an area outside of a front fender opposite the driver's seat may be a blind spot and it is difficult for the user to see clearance between the vehicle body and an obstacle. In contrast, the image display system can be used to display the surrounding image of the area outside the front fender, which is generated based on the captured images obtained by the onboard cameras disposed in the lateral sides of the vehicle, on the display in the compartment. As a result, when the vehicle is pulled over to the side of the road, etc., the user can easily check the clearance between the vehicle body and an obstacle on the opposite side of the driver's seat.

Further, an image display system that indicates a position where the obstacle exists (for example, Patent Document 1) is known. In this image display system, an alarm indication is added to the image around the vehicle (the “surrounding image”).

### CITATION LIST

### Patent Document

Patent Document 1: JP-2007-180622-A

### SUMMARY OF THE INVENTION

When the image display system calls attention, the user uses the surrounding image to check where the obstacle exists. However, in the image display system described above, the alarm indication may hide the surrounding image and, as a result, it may be difficult to check if an obstacle exists from the surrounding image.

It is an object of the present invention to provide an image display system that allows easily determining where an obstacle exists from a surrounding image while calling attention.

An image display system mounted on a vehicle, including a synthesized image generation section that generates a synthesized image representing the vehicle and circumstances around the vehicle viewed from a virtual viewpoint based on captured images obtained by cameras disposed on the vehicle, a display section that displays the synthesized image and the captured images on a display screen, an obstacle detection section that detects an obstacle, and an indication addition section that, when the obstacle is detected, adds an alarm indication to call attention to at least one of an area of the display screen except the synthesized image and the captured images, a surrounding area of the synthesized image, and an area of the vehicle in the synthesized image is provided.

An image generation device including a synthesized image generation section that generates a synthesized image representing circumstances viewed from a virtual viewpoint based on captured images, a display section that displays the synthesized image and the captured images on a display screen of a display device,

a detection signal receiving section that receives a detection signal from an obstacle detection section detecting an obstacle, and an indication addition section that, when the obstacle is detected, adds an alarm indication to call attention to at least one of an area of the display screen except the synthesized image and the captured images, a surrounding area of the synthesized image, and an area of the vehicle in the synthesized image is provided.

An image display method including the steps of generating a synthesized image representing the vehicle and circumstances around the vehicle viewed from a virtual viewpoint based on captured images obtained by cameras disposed on the vehicle; displaying the synthesized image and the captured images on a display screen, detecting whether an obstacle exists or not; and, when the obstacle is detected, adding an alarm indication to call attention to at least one of an area of the display screen except the synthesized image and the captured images, a surrounding area of the synthesized image, and an area of the vehicle in the synthesized image is provided.

According to the above image display system, image generation device or image display method, it is easy to determine if an obstacle exists from a surrounding image while calling attention.

### DESCRIPTION OF THE DRAWINGS

These and other features and advantages of the present invention will be better understood by reading the following detailed description, taken together with the drawings wherein:

FIG. 1 is a diagram illustrating an exemplary configuration of an image display system of an embodiment of the present invention;

FIG. 2 is a diagram illustrating positions in which onboard cameras are placed;

FIGS. 3(A) and 3(B) are explanatory diagrams of a combined image generated by an image combining section;

FIG. 4 is a diagram mainly illustrating a configuration of a sonar system;

FIG. 5 is a diagram illustrating positions on a vehicle at which clearance sonar devices are placed;

FIG. 6 is a diagram for describing a technique for generating a synthesized image;

FIG. 7 is a diagram illustrating transition of operation modes of the image display system;

FIG. 8 is an explanatory diagram of an example of addition of an alarm indication;

FIG. 9 is an explanatory diagram of another example of addition of an alarm indication;

FIG. 10 is an explanatory diagram of a variation of an indicator;

FIG. 11 is an explanatory diagram of enlargement of a synthesized image; and

FIG. 12 is an explanatory diagram of an exemplary process of an image display system.

### DETAILED DESCRIPTION OF THE PREFERRED EMBODIMENT

### 1. System Configuration

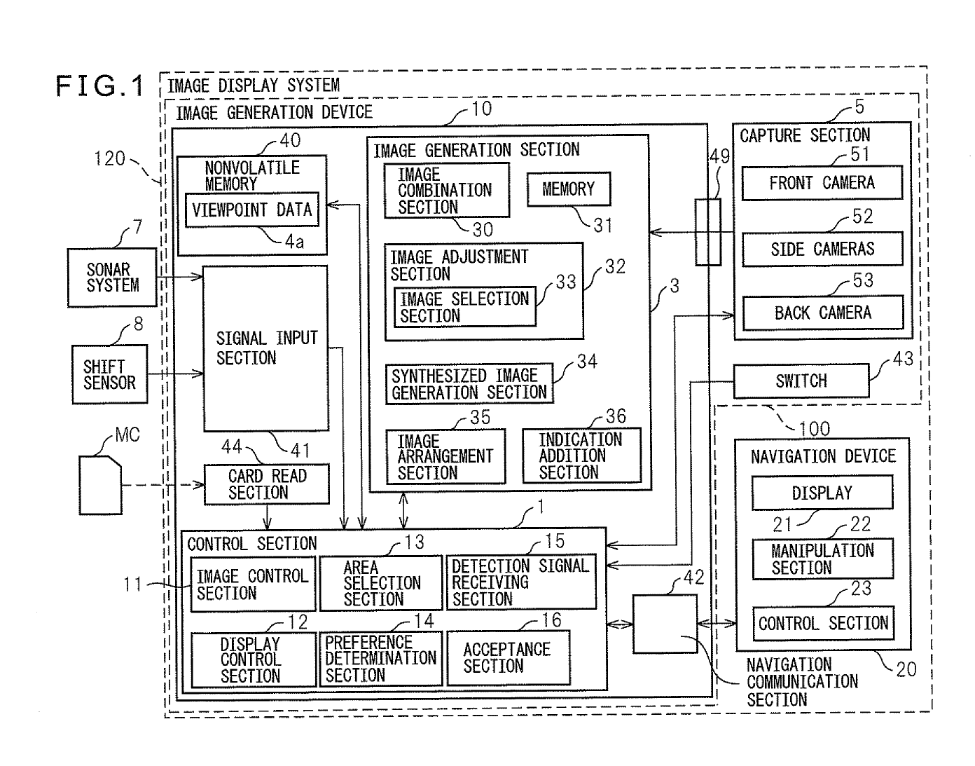

FIG. 1 is a block diagram illustrating a configuration of an image display system 120 of an embodiment of the present invention. This image display system 120 is mounted on a vehicle (automobile in this embodiment) and it has a function to capture surroundings of the vehicle and generate images to display the images in a compartment. A user (typically, a driver) can use this image display system 120 to grasp circumstances around the vehicle substantially in real time.

As illustrated in FIG. 1, image display system 120 mainly comprises an image generation device 100 for generating a surrounding image that represent circumstances around the vehicle, and a navigation device 20 for displaying various types of information to the user driving the vehicle. The surrounding image generated by image generation device 100 is displayed by navigation device 20.

Navigation device 20 provides navigation guide for the user and it comprises a display 21 such as a liquid crystal display equipped with a touch panel function, a manipulation section 22 including hardware switches and the like manipulated by the user, and a control section 23 for controlling the overall device. Navigation device 20 is installed in an instrument panel and the like of the vehicle so that the user can view a screen of display 21.

Various instructions of the user are accepted by manipulation section 22 and display 21 as a touch panel. Control section 23 is a computer comprising a CPU, RAM, ROM and the like, wherein the CPU performs arithmetic processing according to predetermined programs to implement various functions including the navigation function. Navigation device 20 is communicably connected to image generation device 100 so that it can transmit/receive various control signals to/from image generation device 100 and receive the images generated by image generation device 100.

On display 21, according to the control of control section 23, usually, a map image around the vehicle for navigation guide is displayed by the function of navigation device 20 only. The map image is stored in advance in a hard disk and the like provided in navigation device 20. Further, the position (latitude and longitude) of the vehicle is obtained by a GPS device provided in navigation device 20 and, based on the position of the vehicle, the map image around the vehicle is displayed on display 21. A scale of the displayed map image can be changed by the user through manipulation section 22.

On the other hand, when the operation mode of image display system 120 is changed, the surrounding image around the vehicle generated by image generation device 100 is displayed on display 21. As a result, navigation device 20 also functions as a display device for receiving and displaying the surrounding image generated by image generation device 100.

Image generation device 100 comprises a main section 10 that is an ECU (Electronic Control Unit) having a function to generate an image, and a capture section 5 for generating images of circumstances around the vehicle. Main section 10 is disposed in a predetermined position in the vehicle and, based on the images of the circumstances around the vehicle obtained by capture section 5, generates the surrounding image for displaying on display 21.

Capture section 5 is electrically connected to main section 10 and operates according to signals from main section 10. Capture section 5 comprises a front camera 51, side cameras 52, and a back camera 53, all of which are onboard cameras. Each of onboard cameras 51-53 comprises a lens and an imaging device and electronically obtains an image.

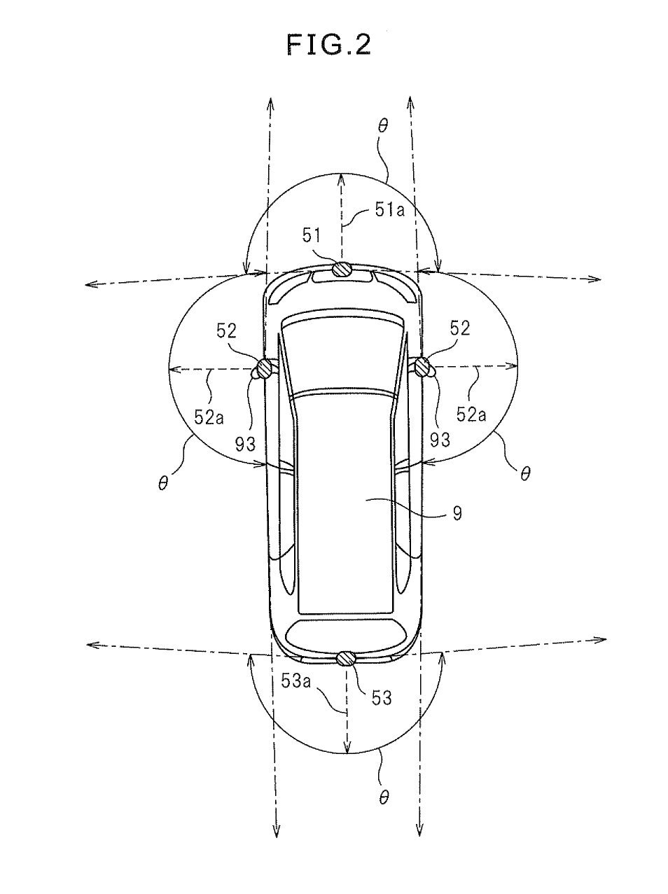

A plurality of onboard cameras 51-53 are disposed in positions different from each other of the vehicle. FIG. 2 is a diagram illustrating the positions in which onboard cameras 51-53 are disposed in vehicle 9.

As illustrated in FIG. 2, front camera 51 is mounted in the neighborhood of the position where a license plate is attached in a front end of vehicle 9 and an optical axis 51a of front camera 51 is directed in a straight forward direction of vehicle 9. Back camera 53 is mounted in the vicinity of where a license plate is attached to a back end of the vehicle 9 and an optical axis 53a of back camera 53 is directed in a direction opposite to the straight forward direction of vehicle 9. It is desirable that the attachment positions of front camera 51 and back camera 53 are located at the center in the left and right directions, but the attachment positions may deviate in the left or right direction to some extent. On the other hand, side cameras 52 are mounted on left and right side mirrors 93 one by one and the optical axis 52a of side cameras 52 is directed to the outside of vehicle 9 along a left and right direction (a direction orthogonal to the straight forward direction) of vehicle 9.

These onboard cameras 51-53 use wide-angle lenses such as fisheye lenses to have angular fields θ of 180° or more. Onboard cameras can therefore capture images of the field of view extending obliquely below and above the respective optical axes. Capture section 5 uses four onboard cameras 51-53 so that the entire surroundings of the vehicle 9 can be imaged.

Returning to FIG. 1, main section 10 of image generation device 100 mainly comprises a control section 1 for controlling the entire device, an input terminal 49 for inputting the captured images from four onboard cameras 51-53 of capture section 5, an image generation section 3 for generating the surrounding image to be displayed, and a navigation communication section 42 for communicating with navigation device 20.

Various instructions from the user accepted by manipulation section 22 of navigation device 20 or display 21 are accepted by navigation communication section 42 as control signals and input to control section 10. Further, image generation device 100 comprises a switch 43 for accepting an instruction to change the displayed contents from the user. The signals indicating the user's instructions are input to control section 1 also from this switch 43. Thus, image generation device 100 can operate in response to the user's manipulation of both navigation device 20 and switch 43. Switch 43 is disposed at a suitable position in the vehicle that is remote from the main section 10 such as, for example, at a position on a steering wheel or a center console in order to make it easy for the user to operate.

Image generation section 3 is a hardware circuit that can perform various image processing operations, and it processes the captured images input from capture section 5 via input terminal 49 and generates a surrounding image to be displayed on display 21. Image generation section 3 comprises, as main components, an image combination section 30, a memory 31, an image adjustment section 32, a synthesized image generation section 34, an image arrangement section 35, and an indication addition section 36.

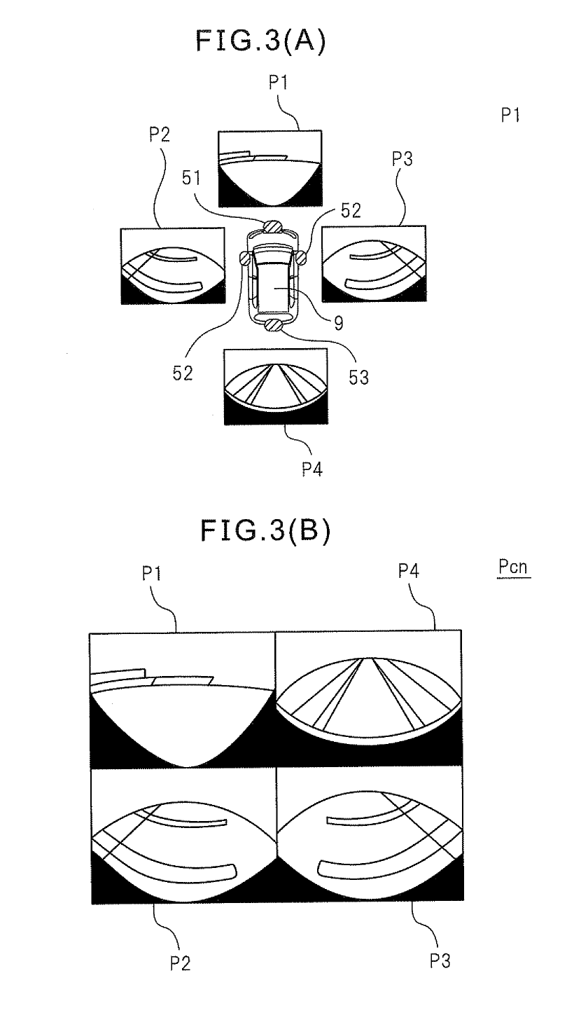

Image combination section 30 combines the captured images captured by capture section 5 into one combined image. FIGS. 3(A) and 3(B) are explanatory diagrams of a combined image Pcn generated by an image combining section 30. When front camera 51, side cameras 52 and back camera 53 of capture section 5 perform imaging at the same time, four captured images P1-P4 that represent circumstances in front, left-side, right-side and back directions of vehicle 9 are obtained. Image combination section 30 combines these four captured images P1-P4 to generate a combined image Pcn as illustrated in FIG. 3(B). Combined image Pcn generated by image combination section 30 is stored in memory 31.

Image adjustment section 32 performs adjustment so that combined image Pcn generated by image combination section 30 can be used for display. Specifically, with respect to captured images P1-P4 included in combined image Pcn, image adjustment section 32 performs image processing operations such as distortion correction, enlargement and reduction and segmentation. Image adjustment section 32 comprises an image selection section 33. In the segmentation process of captured images P1-P4 included in combined image Pcn, image selection section 33 selects segmentation areas, in other words, areas to be displayed on display 21. In order to configure segmentation settings (setting of the segmentation areas), enlargement and reduction settings and the like, adjustment and setting values for the configuration are stored in a calibration (adjustment and configuration) process performed when the devices (cameras) are attached, and the image processing operations such as the adjustment operations and the like are performed by using these values.

Based on combined image Pcn, synthesized image generation section 34 generates a synthesized image that represents the circumstances around the vehicle from an arbitrary virtual viewpoint around the vehicle. The technique by which synthesized image generation section 34 generates the synthesized image will be described below.

The captured images that are adjusted to be displayed by image adjustment section 32 and the synthesized image generated by synthesized image generation section 34 are output to navigation device 20 by navigation communication section 42. At this time, according to the operation mode of image display system 120 described below, image arrangement section 35 arranges these images at predetermined display positions on the screen to generate the display image and output it to navigation device 20. As a result, the surrounding image including at least a part of the circumstances around the vehicle is displayed on display 21 of navigation device 20.

In this patent specification, the term “surrounding image” refers to an image including at least a part of the circumstances around the vehicle and it involves both the captured images adjusted to be displayed and the synthesized image. The captured images adjusted to be displayed are treated as the surrounding image from the field of view of the respective onboard cameras 51-53 which corresponds to a lens position of respective onboard camera 51-53. Further, the synthesized image is treated as the surrounding image from the virtual viewpoint disposed at an arbitrary position around the vehicle.

Indication addition section 36 adds an indication, through which image display system 120 provides a predetermined information item to the user, to the display image generated by image arrangement section 35. This indication may be, for example, an icon representing a particular information item or a character information item such as a message. Further, as described below, when an obstacle is detected, indication addition section 36 adds an alarm indication (indicator) to a part of the display screen other than that where the synthesized image and the captured images are displayed. When the obstacle is detected, indication addition section 36 therefore functions as an indication emphasis section for emphasizing the alarm indication.

Control section 1 is a computer comprising a CPU, RAM, ROM and the like, wherein the CPU performs arithmetic processing according to predetermined programs to implement various functions. An image control section 11, a display control section 12, an area selection section 13, a preference determination section 14, a detection signal receiving section 15 and an acceptance section 16 represent some of the functions of control section 1 implemented as described above.

Image control section 11 performs control in connection with the image processing performed by image generation section 3. For example, image control section 11 indicates various parameters and the like that are required for generating the synthesized image by synthesized image generation section 34.

Display control section 12 performs control in connection with the contents displayed on display 21 of navigation device 20. For example, display control section 12 switches the contents displayed on display 21 according to the change of the operation mode of image display system 120.

Area selection section 13 selects the surrounding area to be shown to the user from a plurality of surrounding areas defined around the vehicle. When there are a plurality of surrounding areas to be shown to the user, preference determination section 14 determines their preference.

Detection signal receiving section 15 receives detection signals described below to detect whether an obstacle exists within a predetermined area (around the vehicle) or not. Acceptance section 16 accepts an input to display an enlarged image that is an enlarged part representing the obstacle in the synthesized image on the display screen of navigation device 20. Acceptance section 16 therefore functions as a switch indication section for indicating a switch image for instructing an enlarged indication when the obstacle is detected. Once acceptance section 16 accepts the above input, display control section 12 displays the above enlarged image on the display screen of navigation device 20 instead of the synthesized image, as described below. When acceptance section 16 functioning as the switch indication section is manipulated, display control section 12 therefore functions as an enlargement indication section for indicating the enlarged image of the area where the obstacle is detected.

Main section 10 of image generation device 100 further comprises a nonvolatile memory 40, a card read section 44, and a signal input section 41, which are connected to control section 1.

Nonvolatile memory 40 is a flash memory and the like that can maintain the stored contents even while the power is turned off. In nonvolatile memory 40, a viewpoint data 4a is stored. Viewpoint data 4a is used to define the virtual viewpoint of the synthesized image.

Card read section 44 reads a memory card MC that is a portable recording medium. Card read section 44 comprises a card slot into which memory card MC is removably attached and reads the data recorded in memory card MC that is inserted into the card slot. The data read by card read section 44 is input to control section 1. Memory card MC is a flash memory and the like that can store various data and image generation device 100 can use the various data stored in memory card MC. For example, a program (firmware) for implementing the functions of control section 1 can be updated by writing the program in memory card MC and reading it.

Further, signal input section 41 input signals from various devices provided in the vehicle. Through this signal input section 41, signals from the outside of image display system 120 are input to control section 1. In this embodiment, signals from a sonar system 7 and a shift lever sensor 8 are input to control section 1 via signal input section 41.

As described below, from sonar system 7 as an obstacle detection section, a detection result including the position of the obstacle and the distance between the vehicle and the obstacle is input. From the shift lever sensor 8, the position to which a shift lever of a gear box of the vehicle is moved, in other words, the shift position such as “P (parking)”, “D (drive)”, “N (neutral)”, “R (reverse)” and the like is input.

### 2. Sonar System

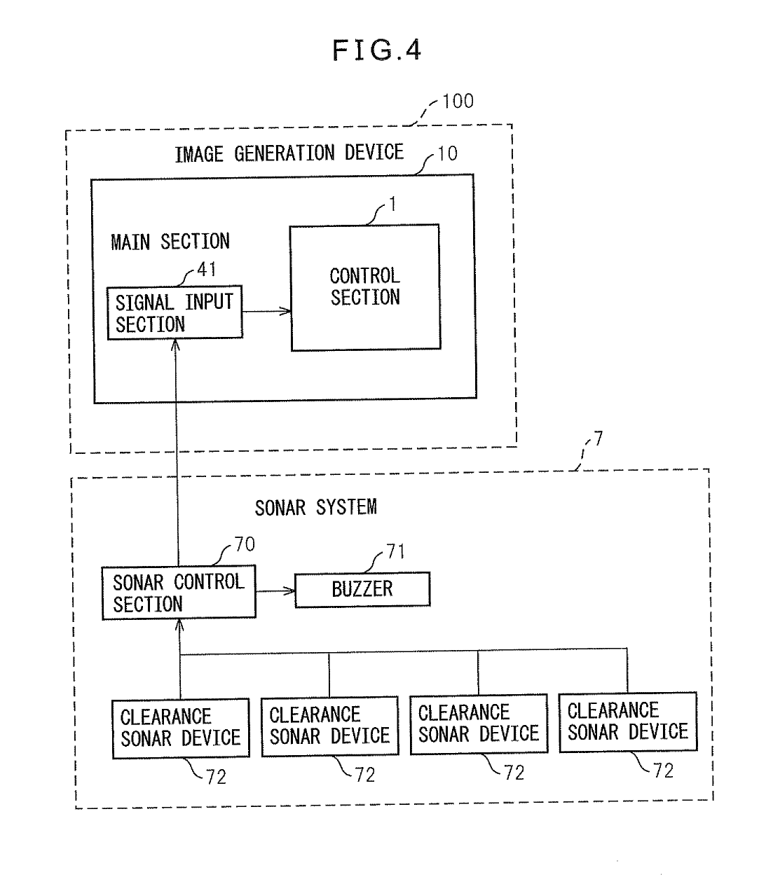

FIG. 4 is a diagram mainly illustrating a configuration of sonar system 7. As illustrated in FIG. 4, sonar system 7 comprises sonar control section 70 for controlling the entire system, a plurality of clearance sonar devices 72, and a buzzer 71 for raising an alarm in the vehicle.

Each of clearance sonar devices 72 transmits an ultrasound wave and receives a reflected wave that is the ultrasound wave reflected by the obstacle to detect the obstacle existing around the vehicle. Further, clearance sonar device 72 can measure a distance between the vehicle and the obstacle based on a time from the transmission of the ultrasonic wave to the reception of the same.

The detection results of clearance sonar devices 72 are input to sonar control section 70, so that buzzer 71 raises an alarm according to the distance between the vehicle and the obstacle. As a result, the user can grasp whether an obstacle exists or not around the vehicle.

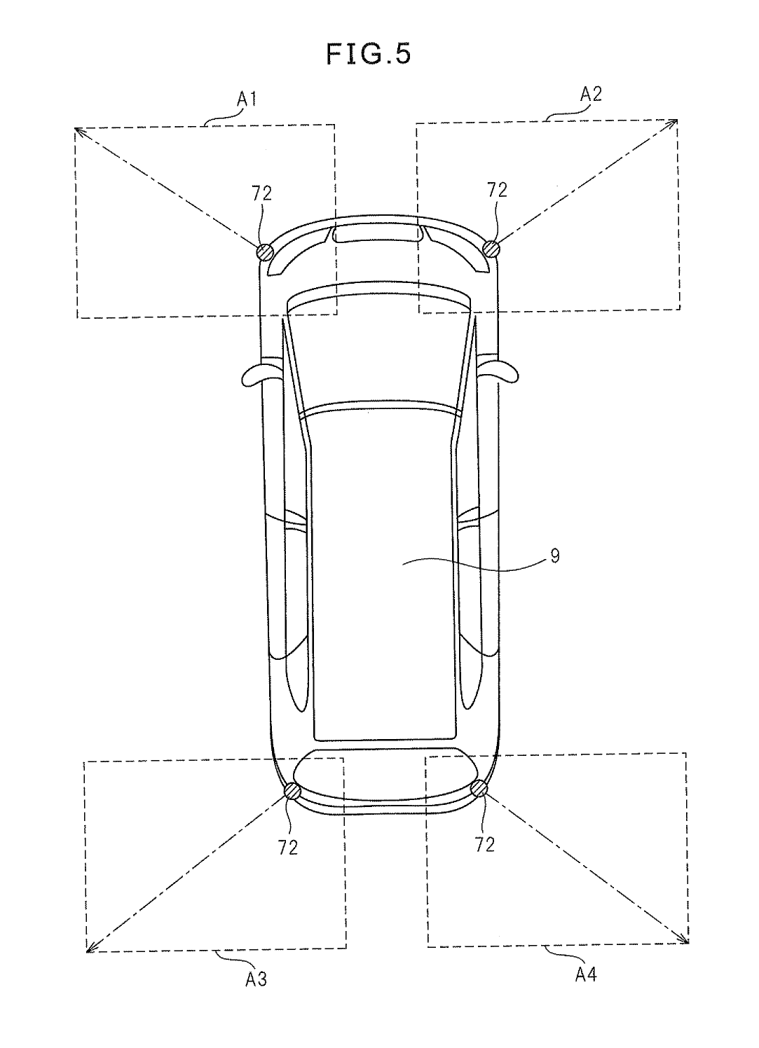

FIG. 5 is a diagram illustrating positions at which a plurality of clearance sonar devices 72 are placed on vehicle 9. The plurality of clearance sonar devices 72 are provided at the front left and right ends of vehicle 9 and at the back left and right ends of vehicle 9.

Each clearance sonar device 72 transmits an ultrasonic wave to surrounding areas A1-A4 which are some of the circumstances around vehicle 9. Specifically, clearance sonar device 72 provided at the front left end of vehicle 9 transmits an ultrasonic wave to the surrounding area A1 defined in the front left side (“front left area”) of vehicle 9. Further, clearance sonar device 72 provided at the front right end of vehicle 9 transmits an ultrasonic wave to the surrounding area A2 defined in the front right side (“front right area”) of vehicle 9. Further, clearance sonar device 72 provided at the back left end of vehicle 9 transmits an ultrasonic wave to the surrounding area A3 defined in the back left side (“back left area”) of vehicle 9. Further, clearance sonar device 72 provided at the back right end of vehicle 9 transmits an ultrasonic wave to the surrounding area A4 defined in the back right side (“back right area”) of vehicle 9.

These four surrounding areas A1-A4 are defined in advance fixedly in relation to vehicle 9. As a result of this arrangement of clearance sonar devices 72, sonar system 7 can detect the obstacle existing in four surrounding areas A1-A4. Based on the position of clearance sonar device 72 that detected the obstacle, sonar system 7 can grasp in which one of surrounding areas A1-A4 the detected obstacle is located. Further, sonar system 7 can measure the distance between the vehicle and the obstacle.

As illustrated in FIG. 4, the detection result of sonar system 7 including the position of the obstacle and the distance between the vehicle and the obstacle is input from sonar control section 70 to control section 1 of image generation device 100 via signal input section 41. Then, this detection result of sonar system 7 is used by detection signal receiving section 15 of control section 1 and the like.

### 3. Image Synthesis Process

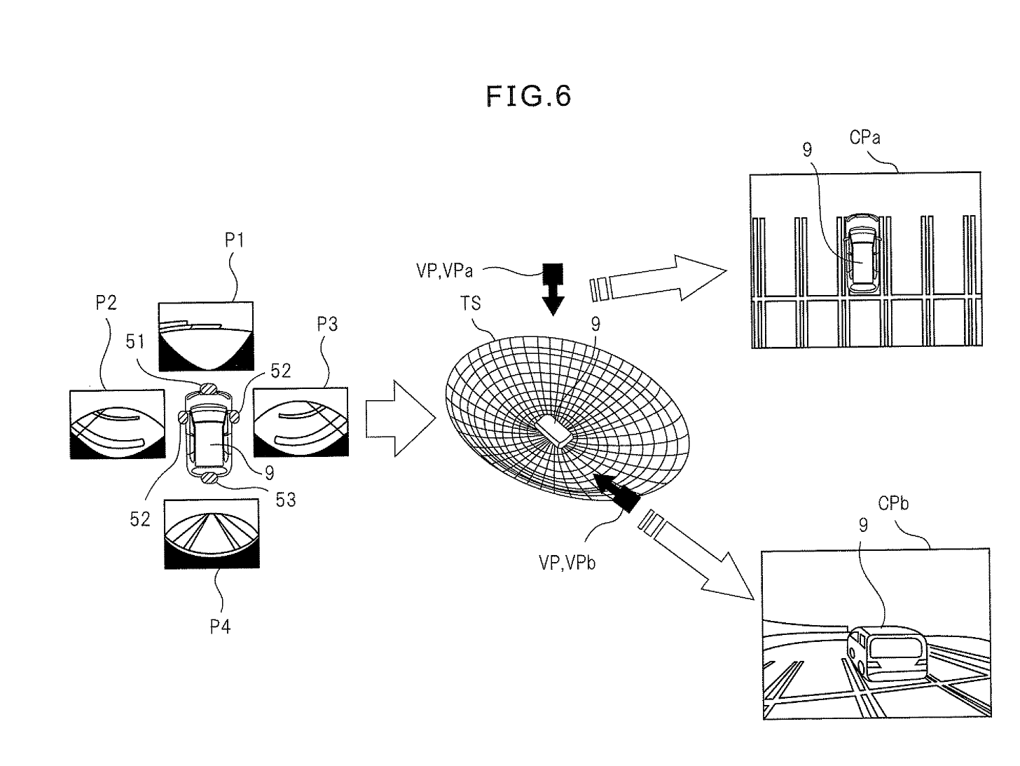

Next, there will be described a technique in which synthesized image generation section 34 of image generation section 3 generates a synthesized image that represents vehicle 9 itself and circumstances around vehicle 9 viewed from an arbitrary virtual viewpoint based on the plurality of captured images 91-94 obtained by capture section 5. FIG. 6 is a diagram for describing the technique for generating the synthesized image.

As described above, when front camera 51, side cameras 52 and back camera 53 of capture section 5 capture images at the same time, four captured images P1-P4 that represent circumstances in the front, left-side, right-side and back directions of vehicle 9, respectively, are obtained. A combined image Pen in which the four captured images P1-P4 captured by captured section 5 are combined with each other includes information about an entire circumstance around vehicle 9 at the time of capture.

Next, each of pixels of combined image Pcn is projected to a three-dimensional curved surface TS in a virtual three-dimensional space. For example, three-dimensional curved surface TS has a substantially hemispherical shape (bowilike shape) and its center (bottom of the bowl) is defined as a position at which vehicle 9 is positioned. There is established in advance a relationship between a position of each of the pixels in combined image Pcn and a position of each of the pixels in this three-dimensional curved surface TS. As a result, each of pixel values in three-dimensional surface TS can be determined based on this relationship and each of pixel values included in combined image Pcn.

The relationship between each of the positions of the pixels in combined image Pcn and each of the positions of the pixels in this three-dimensional curved surface TS depends on arrangement (distances between each other, height above ground level, optical axis angle and the like) of four onboard cameras 51-53 in vehicle 9. A table data representing this relationship is stored in nonvolatile memory 40 in advance.

Further, a data indicating a shape and size of the vehicle body stored in nonvolatile memory 40 in advance is used to virtually construct a polygon model representing a three-dimensional shape of vehicle 9. The constructed model of vehicle 9 is positioned at the center of the substantially semispherical shape, which is defined as the position of vehicle 9, in the three-dimensional space in which three-dimensional curved surface TS is defined.

Further, with regard to the three-dimensional space in which three-dimensional curved surface TS exists, control section 1 defines virtual viewpoint VP. Virtual viewpoint VP is defined by a viewpoint position and a field-of-view direction and it is defined at an arbitrary viewpoint position corresponding to the surroundings of vehicle 9 in this three-dimensional space in an arbitrary field-of-view direction.

Then, a necessary area in three-dimensional curved surface TS is cut out as an image according to the defined virtual viewpoint VP. A relationship between virtual viewpoint VP and a necessary area in three-dimensional curved surface TS is predefined and stored as a table data in nonvolatile memory 40 and the like in advance. On the other hand, the polygon model is rendered according to the defined virtual viewpoint VP and the resultant two-dimensional image of the vehicle is superimposed on the cut out image. As a result, a synthesized image representing vehicle 9 and the surroundings thereof viewed from the arbitrary virtual viewpoint VP is generated.

For example, when a virtual viewpoint VPa whose viewpoint position is substantially just above the center of the position of vehicle 9 and whose field of view is directed to just below, there is generated a synthesized image CPa representing vehicle 9 and the surroundings thereof that are seen when vehicle 9 is looked down substantially from just above vehicle 9. Further, as illustrated in the figure, when a virtual viewpoint VPb whose viewpoint is positioned at a left back side of vehicle 9 and whose field of view is directed substantially to a forward side of vehicle 9, there is generated a synthesized image CPb representing vehicle 9 and the surroundings thereof that is seen when the surroundings are viewed from the left back side of vehicle 9.

When the synthesized image is actually generated, it is not necessary to determine all pixel values of three-dimensional curved surface TS. Rather, it is possible to determine only pixel values of an area required in accordance with the defined virtual viewpoint VP, based on captured images P1-24, so that processing speed can be increased. In image display system 120, the functions of synthesized image generation section 34 described above are used to generate a synthesized image viewed from an arbitrary viewpoint around vehicle 9 and display it on display 21.

### 4. Operation Modes

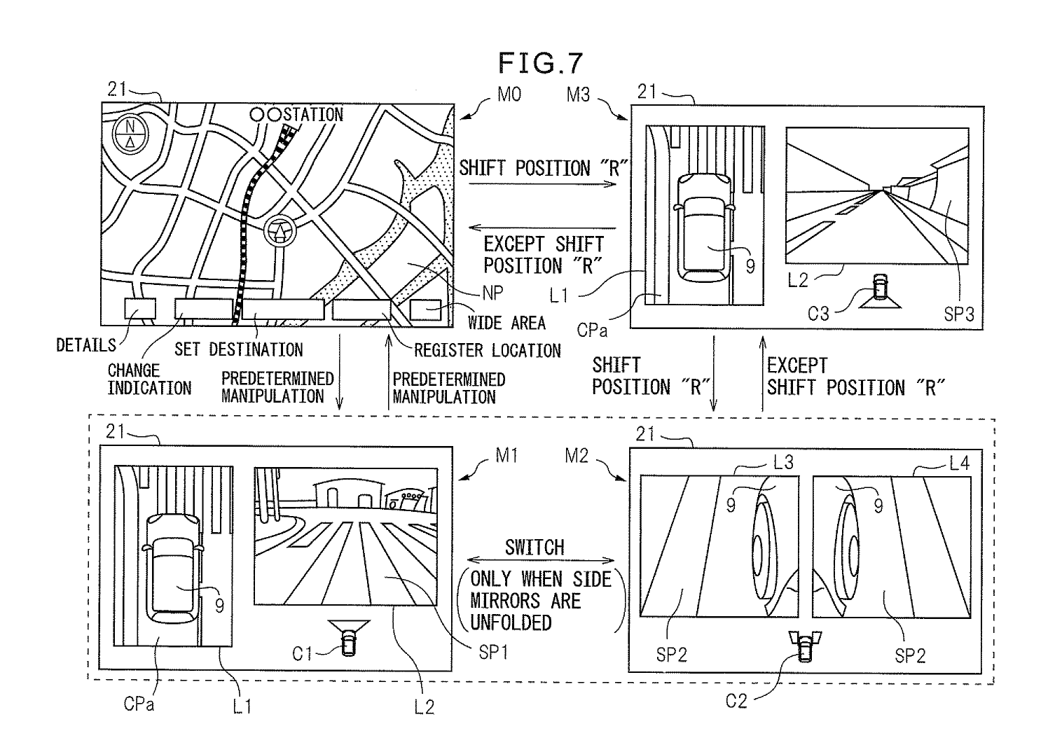

Next, operation modes of image display system 120 will be described. FIG. 7 is a diagram illustrating transition of operation modes of image display system 120. Image display system 120 has a navigation mode M0 and three operation modes including a front mode M1, a side mode M2 and a back mode M3. These operation modes can be switched under the control of control section 1 according to handling of vehicle 9 by the driver and a running state of vehicle 9.

Navigation mode M0 is an operation mode in which the functions of navigation device 20 is used to provide navigation guide. In navigation mode M0, the functions of image generation device 100 are not used and various indications are displayed on display 21 by the functions of navigation device 20 only. Specifically, a map image NP around vehicle 9 is mainly displayed on display 21.

In contrast, front mode M1, side mode M2 and back mode M3 are operation modes in which the functions of image generation device 100 is used to display the surrounding image on display 21 to show the circumstances around the vehicle to the user in real time.

Front mode M1 is an operation mode that indicates the forward side of vehicle 9 and is used when the vehicle enters into a crossing with bad visibility and the like. In a second indication position L2 of display 21, a captured image (hereinafter referred to as a “front image”) SP1 that is captured by front camera 51 and adjusted for indication is displayed. This front image SP1 is a surrounding image viewed from the viewpoint at the front side of vehicle 9 (the lens position of front camera 51). In front mode M1, an icon C1 is displayed to indicate that the surrounding image (i.e., front image) SP1 that is being displayed is the scene in the front side of vehicle 9.

Further, in a first indication position L1, synthesized image CPa that represents vehicle 9 and the surroundings thereof, with are seen when vehicle 9 is looked down substantially from just above vehicle 9, and that is generated by synthesized image generation section 34, are indicated.

Side mode M2 is an operation mode that indicates the lateral side of vehicle 9 and is used when the vehicle is pulled over to the side of the road and the like. In a third indication position L3 and a fourth indication position L4 of display 21, captured images (hereinafter referred to as “side images”) SP2 that are captured by side cameras 52 and adjusted for indication are displayed. These side images SP2 are surrounding images viewed from the viewpoints at the lateral sides of vehicle 9 (the lens positions of front cameras 52). In this mode, the vehicle is or will be going forward (except the shift position “R”). In side images SP2, therefore, the circumstances in the forward direction from the lateral side images of the vehicle are cut out. Side images SP2 include portions of the vehicle body so that a relationship between the vehicle body and a road (and objects outside the vehicle) can be readily seen. Image processing (cut out, rotation and the like) is performed on side image SP2 so that the travelling direction of the vehicle substantially corresponds to the vertical direction. In side mode M2, an icon C2 is displayed to indicate that the surrounding images (i.e., side images) SP2 that are being displayed are the scenes in the lateral sides of vehicle 9.

Further, back mode M3 is an operation mode that indicates the back side of vehicle 9 and is used when the vehicle goes back. In the second indication position L2 of display 21, a captured image (hereinafter referred to as a “back image”) SP3 that is captured by back camera 53 and adjusted for indication is displayed. This back image SP3 is a surrounding image viewed from the viewpoint at the back side of vehicle 9 (the lens position of back camera 53). In back mode M3, an icon C3 is displayed to indicate that the surrounding image (i.e., back image) SP3 that is being displayed is the scene in the back side of vehicle 9.

Further, in the first indication position L1, synthesized image CPa that is generated by synthesized image generation section 34 to indicate vehicle 9 and surrounding area thereof, which are seen when vehicle 9 is looked down substantially from just above vehicle 9, is displayed.

In navigation mode M0, when manipulation section 22 of navigation device 20 is manipulated in a predetermined manner (to indicate the surrounding image), navigation mode M0 is switched to one of front mode M1 and side mode M2 that has been lastly validated (so called a last mode). Front mode M1 and Side mode M2 can be switched to each other by pushing switch 43 once. Further, in front mode M1 or side mode M2, when manipulation section 22 of navigation device 20 is manipulated in a predetermined manner, the operation mode returns to navigation mode M0.

On the other hand, in any operation mode other than back mode M3, when the “R (reverse)” shift position is input from shift sensor 71, the operation mode is switched to back mode M3. Thus, when “R (reverse)” shift position is input, vehicle 9 is in a state to go back and, therefore, the operation mode is switched to back mode M3 that mainly indicate the circumstances in the back side of vehicle 9. In back mode M3, when any shift position other than the “R (reverse)” is input, the operation mode returns to the operation mode immediately before it is switched to back mode M3.

As described above, image display system 120 can display the surrounding image from a plurality of viewpoints in a switchable manner by switching a plurality of operation modes.

### 5. Addition of Alarm Indication

Next, a process of image display system 120 to add an alarm indication will be described. Though the process in front mode M1 will be described in the following, the similar process to add the alarm indication can be performed also in back mode M3.

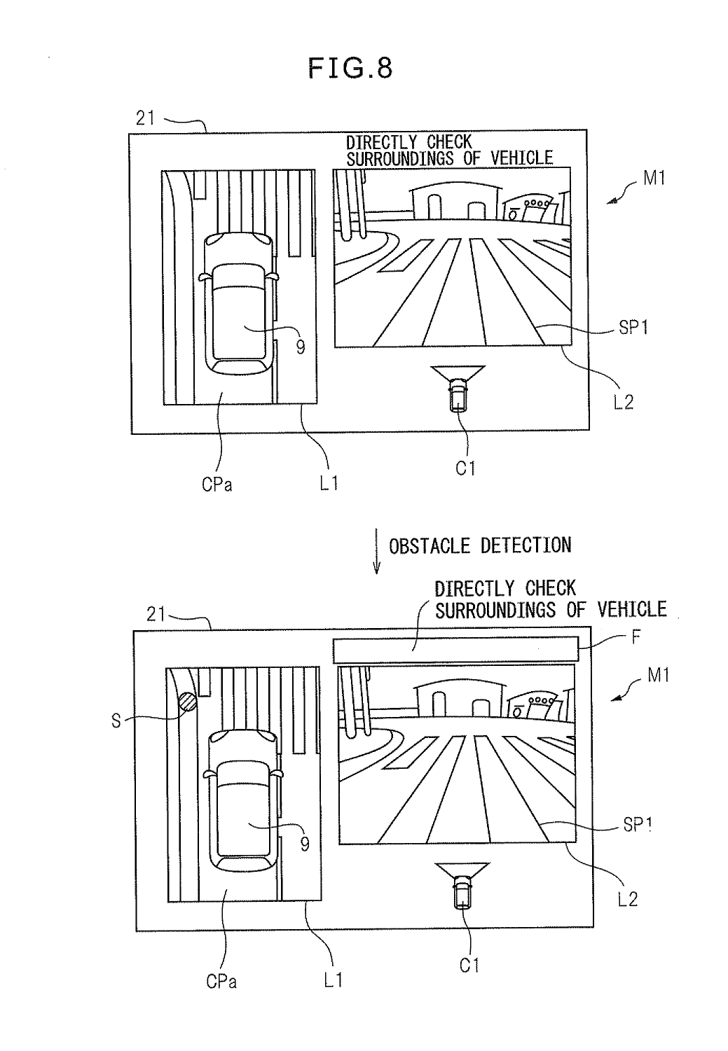

FIG. 8 is an explanatory diagram of an example of addition of alarm indication. In the example illustrated in FIG. 8, on display 21, above front image SP1 (in a area outside and above the area where front image SP1 is indicated), a message “Directly check surroundings of vehicle” is added by indication addition section 36. This message is indicated while the surrounding image of the vehicle is indicated regardless of the detection state of the obstacle by sonar system 7.

When a signal indicating that obstacle S exists in the circumstances is input from sonar system 7 via signal input section 41, detection signal receiving section 15 detects that obstacle S exists around vehicle 9. At this time, obstacle S is captured by the camera and seen in synthesized image CPa. Indication addition section 36 further adds a frame F surrounding the massage (caution text) “Directly check surroundings of vehicle” as the alarm indication.

Indication addition section 36 changes color of frame F according to the distance between vehicle 9 and obstacle. For example, when the distance between vehicle 9 and obstacle S is 0 cm or more and less than 25 cm, frame F is colored in a first color (for example, red); when the distance between vehicle 9 and obstacle S is 25 cm or more and less than 150 cm, frame F is colored in a second color (for example, yellow); and when the distance between vehicle 9 and obstacle S is 150 cm or more, frame F is colored in a third color (for example, green). At this time, not only the color of frame F but also the color of the text and background may be changed according to the distance between vehicle 9 and obstacle S.

The text information such as the message and the frame surrounding the text information may be indicated at any position except the synthesized image CPa and front image SP1 on the screen of display 21.

In the example illustrated in FIG. 8, the indication state (color) of frame F as the alarm indication is changed according to the detection state of obstacle S or the distance between vehicle 9 and obstacle S, so that the existence of the obstacle and a sense of distance between the vehicle and the obstacle can be recognized intuitively without hiding the surrounding image of synthesized image CPa and front image SP1. The location of the obstacle therefore can be checked easily from the surrounding image of synthesized image CPa while calling attention to the obstacle.

Further, the message is emphasized by frame F without hiding the surrounding image of synthesized image CPa and front image SP1, so that the existence of obstacle S around vehicle 9 can be recognized and better understood by the text alarm indication.

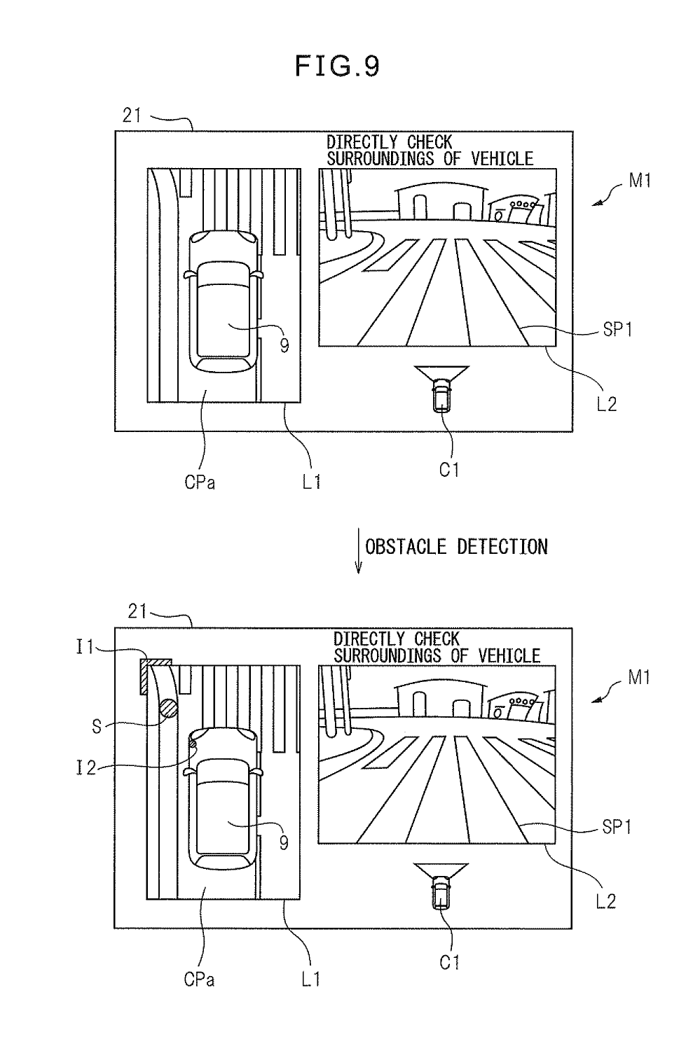

FIG. 9 is an explanatory diagram of another example of addition of alarm indication. In the example illustrated in FIG. 9, on display 21, above front image SP1, a message “Directly check surroundings of vehicle” is added by indication addition section 36. But, this message may not be added.

When a signal indicating that obstacle S is detected is input from sonar system 7 to control section 1 via signal input section 41, detection signal receiving section 15 detects that obstacle S exists around vehicle 9. At this time, obstacle S is captured by the camera and seen in synthesized image CPa. Indication addition section 36 further indicates an L-shaped indicator I1 at the corner on a circumference (outside the image area) of synthesized image CPa in a direction of the obstacle and an indicator I2 of a small round shape and the like at the corner on a circumference of vehicle 9 in a direction of the obstacle as the alarm indication. These indicators are displayed on an area of the screen of display 21, except synthesized image CPa and front image SP1 and on an area of vehicle 9 in synthesized image CPa (the image captured by the camera is not hidden).

Indication addition section 36 changes color of indicators I1, I2 according to the distance between vehicle 9 and obstacle S. For example, when the distance between vehicle 9 and obstacle S is 0 cm or more and less than 25 cm, indicators I1, I2 are colored in a first color (for example, red); when the distance between vehicle 9 and obstacle S is 25 cm or more and less than 150 cm, indicators I1, I2 are colored in a second color (for example, yellow); and when the distance between vehicle 9 and obstacle S is 150 cm or more, indicators I1, I2 are colored in a third color (for example, green).

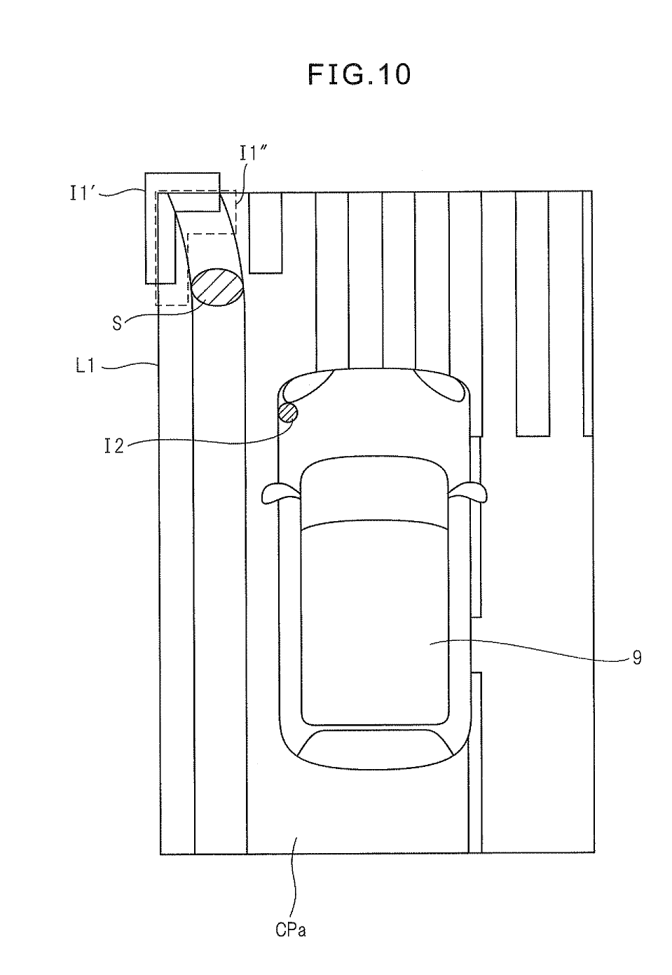

In the example illustrated in FIG. 9, there has been described addition of the indicators to the area of the screen of display 21 except synthesized image CPa and front image SP1 and on an area of vehicle 9 in synthesized image CPa. However, if the indication of obstacle S is not hidden, the indicator may be added to the periphery of synthesized image CPa. For example, as illustrated in FIG. 10, the indicator I1′ may be added to a surrounding area of synthesized image CPa or the indicator I2′ may be added to an area in the synthesized image along the surrounding area of synthesized image CPa.

Further, the indicator may be added to at least one of the area of the screen of display 21 except synthesized image CPa and front image SP1 and an area of vehicle 9 in synthesized image CPa. For example, when the distance between vehicle 9 and obstacle S is 0 cm or more and less than 25 cm, indicators I1, I2 in a first color (for example, red) may be added; when the distance between vehicle 9 and obstacle S is 25 cm or more and less than 150 cm, indicator I1 in a second color (for example, yellow) only may be added; and when the distance between vehicle 9 and obstacle S is 150 cm or more, indicator I1 in a third color (for example, green) only may be added. Further, the alarm indication by means of frame F as illustrated in FIG. 8 may be used in combination with at least one of indicator I1 and indicator I2.

In the example illustrated in FIG. 9, the indication state (color) of indicators I1, I2 as the alarm indication is changed according to the detection state of obstacle S or the distance between vehicle 9 and obstacle S, so that the existence of the obstacle and a sense of distance between the vehicle and the obstacle can be recognized intuitively without hiding the surrounding image of synthesized image CPa and front image SP1. The location of the obstacle therefore can be checked easily from the surrounding image of synthesized image CPa while calling attention to the obstacle.

Further, when obstacle S is located in the distance, for example, when the distance between vehicle 9 and obstacle S is 50 cm or more, indicator I1 only may be added and, when obstacle S is located in the neighborhood, for example, when the distance between vehicle 9 and obstacle S is less than 50 cm, both indicators I1 and I2 may be added (indication which represents obstacles S sandwiched between indicator I1 and indicator I2), so that the attention to obstacle S can be enhanced.

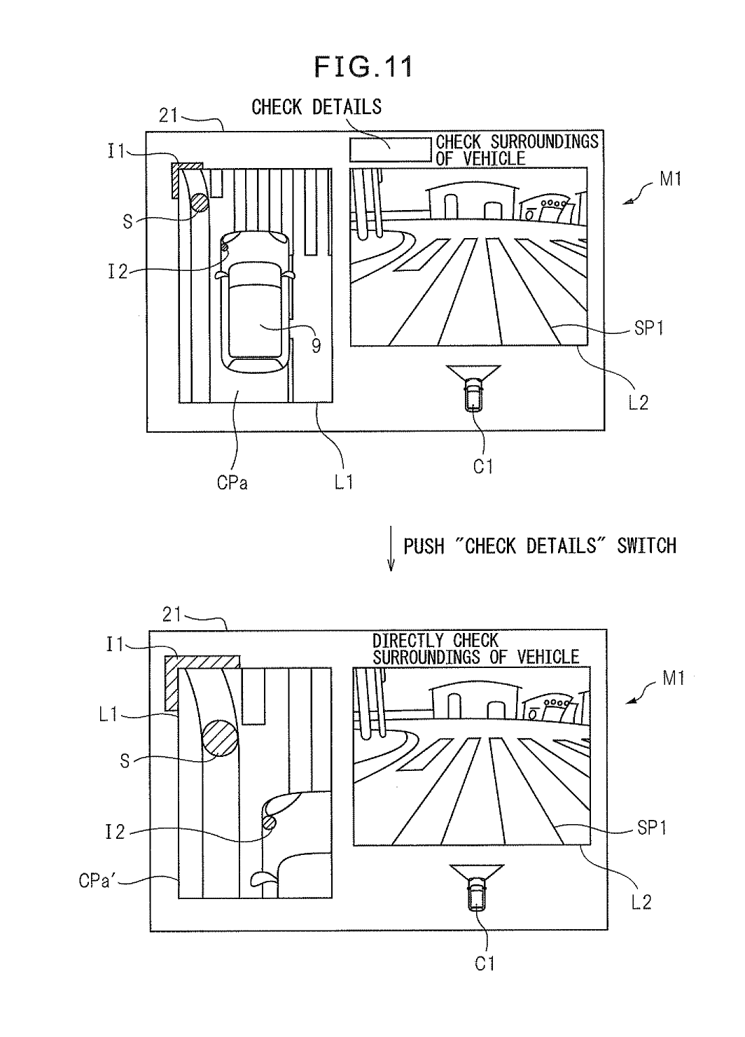

FIG. 11 is an explanatory diagram of enlargement of a synthesized image. In the example illustrated in FIG. 11, on display 21, above front image SP1, a message “Directly check surroundings of vehicle” is added by indication addition section 36 and, on the message “Directly check surroundings of vehicle”, there is indicated a “Check details” switch for allowing acceptance section 16 to accept an input to enlarge a part showing obstacle S in synthesized image CPa and indicate it as an enlarged image CPa′ on display 21.

When the “Check details” switch is pushed, display control section 12 indicates enlarged image CPa′ of the part showing obstacle S on the screen of display 21 instead of synthesized image CPa. Therefore, enlarged image CPa′ can be displayed on the screen of display 21 so that the details of obstacle S can be checked as needed. In the case in which there are a plurality of obstacles around vehicle 9, when the switch is pushed, an area showing the obstacle nearest to vehicle 9 is indicated. If the indication of obstacle S is not hidden, the “Check details” switch described above may be indicated anywhere on the screen of display 21.

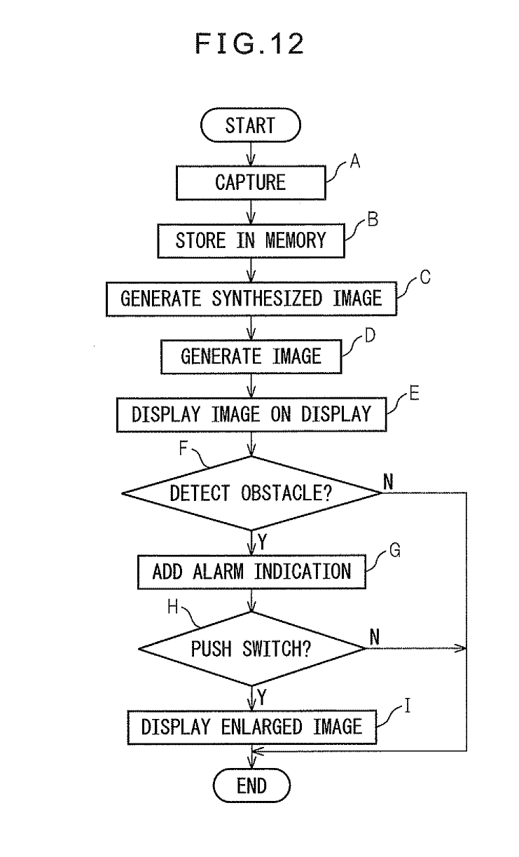

Then, referring to FIG. 12, a process of image display system 120 to add the alarm indication will be described. In the process described with reference to FIG. 12, at least one of indicators I1 and I2 are added as illustrated in FIGS. 9 and 11, and the “Check details” switch is indicated as illustrated in FIG. 11. This process is performed repeatedly during the operation of image display system 120. The similar process is performed when frame F illustrated in FIG. 8 is added as the alarm indication.

In operation A, onboard cameras 51-53 capture respective captured images P1-P4. In operation B, image combination section 30 generates combined image Pcn in which images P1-P4 are combined with each other and stores it in memory 31. In operation C, synthesized image generation section 34 generates synthesized image CPa based on combined image Pcn.

In operation D, according to the current operation mode of image display system 120, image arrangement section 35 selects any of synthesized image CPa and captured images SP1-SP3 and arranges it on the display image to be output to navigation device 20. The image to be displayed is output to navigation device 20 by image generation device 100. In operation E, navigation device 20 indicates the display image output from image generation device 100 on display 21.

In operation F, sonar system 7 determines whether the obstacle around vehicle 9 is detected or not. When the obstacle is detected, in operation G, indication addition section 36 adds at least one of indicator I1 and indicator I2 as the alarm indication to the screen of display 21.

In operation H, acceptance section 16 determines whether the “Check details” switch is pushed or not. When the “Check details” switch is pushed, in operation I, display control section 12 indicates enlarged image CPa′ on the screen of display 21 in place of synthesized image CPa.

What is claimed is:

1. An image display system mounted in a vehicle, comprising:
a synthesized image generation section that generates a synthesized image representing the vehicle and circumstances around the vehicle viewed from a virtual viewpoint based on captured images obtained by cameras disposed on the vehicle;
a display section that displays said synthesized image and said captured images on a display screen;
an obstacle detection section that detects whether an obstacle exists or not; and
an indication addition section that, when the obstacle is detected, adds an alarm indication to call attention to at least one of an area of said display screen except said synthesized image and said captured images, and a surrounding area of said synthesized image.

2. An image display system mounted in a vehicle, comprising:
a synthesized image generation section that generates a synthesized image representing the vehicle and circumstances around the vehicle viewed from a virtual viewpoint based on captured images obtained by cameras disposed on the vehicle;
a display section that displays said synthesized image and said captured images on a display screen;
an obstacle detection section that detects whether an obstacle exists or not; and
an alarm indication addition section that, when the obstacle is detected, adds an alarm indication to call attention that has a shape including a corner in a direction of the obstacle on a circumference outside a display area of said synthesized image.

3. An image display system according to claim 2, wherein said alarm indication is an indicator that is added to at least one of an area of said display screen except said synthesized image and said captured images, a surrounding area of said synthesized image, and an area of the vehicle in said synthesized image, wherein said indication addition section changes color of said indicator according to a distance between the vehicle and the obstacle.

4. An image display system mounted in a vehicle, comprising:
a synthesized image generation section that generates a synthesized image representing the vehicle and circumstances around the vehicle viewed from a virtual viewpoint based on captured images obtained by cameras disposed on the vehicle;
a display section that displays said synthesized image and said captured images on a display screen;
an obstacle detection section that detects whether an obstacle exists or not;
a switch indication section that, when the obstacle is detected, indicates a switch image for instructing an enlarged indication; and
an enlargement indication section that, when said switch indication section is manipulated, displays an enlarged image of an area in which the obstacle is detected.

5. An image display system mounted in a vehicle, comprising:
a synthesized image generation section that generates a synthesized image representing the vehicle and circumstances around the vehicle viewed from a virtual viewpoint based on captured images obtained by cameras disposed on the vehicle;
a display section that displays said synthesized image and said captured images on a display screen;
an alarm indication section that calls direct attention to the displayed image;
an obstacle detection section that detects whether an obstacle exists or not; and
an indication emphasis section that, when the obstacle is detected, emphasizes said alarm indication.
